(19) United States
(12) Patent Application Publication
(10) Pub. No.: US 2014/0156815 A1
(43) Pub. Date: Jun. 5, 2014

(54) STORAGE SYSTEM AND METHOD FOR MANAGING CONFIGURATION INFORMATION THEREOF

(71) Applicants: Jun Kitahara, Odawara-shi (JP); Takamitsu Morioka, Odawara-shi (JP); Isao Shimonishi, Hiratsuka-shi (JP); Toshio Kimura, Odawara-shi (JP); Hiroji Shibuya, Odawara-shi (JP)

(72) Inventors: Jun Kitahara, Odawara-shi (JP); Takamitsu Morioka, Odawara-shi (JP); Isao Shimonishi, Hiratsuka-shi (JP); Toshio Kimura, Odawara-shi (JP); Hiroji Shibuya, Odawara-shi (JP)

(73) Assignee: Hitachi, Ltd., Tokyo (JP)

(21) Appl. No.: 13/703,206

(22) PCT Filed: Dec. 3, 2012
(86) PCT No.: PCT/JP2012/007722

§ 371 Date: Dec. 10, 2012

(51) Int. Cl. H04L 12/24

(52) U.S. Cl. CPC H04L 41/0813
USPC 709/221

(57) ABSTRACT

The object of the invention is to enable automatic recognition of a content of change of configuration at a host side when physical configuration change such as the expansion or reduction of a storage subsystem occurs. Coupling information with respect to the storage subsystems is provided to the host side, and when physical configuration change occurs, a notice that change of configuration has been executed and the content of change of configuration is notified from the storage subsystem side to the host side, based on which the coupling information is updated automatically. According to this method, the host can constantly recognize the current adequate logical configuration of one or more storage subsystems that the host accesses.

### TECHNICAL FIELD

The present invention relates to a storage system and a method for managing the configuration information of the storage system.

### BACKGROUND ART

Computer systems handling enormous amounts of data used by enterprises, public entities and the like are composed of host computers and storage subsystems, wherein the data is managed via the storage subsystems. The storage subsystems are designed by arranging HDDs (Hard Disk Drives) which are storage media in arrays, based for example on RAID (Redundant Array of Independent (Inexpensive) Disks) configuration. Further, storage subsystems are capable of constructing logical volumes which are logical storage areas within the HDDs, which are physical storage media, and the constructed logical volume can be provided to the host computers such as application servers.

The host computers and the storage subsystems are coupled, for example, via a communication network such as a SAN (Storage Area Network). Each host computer coupled to the SAN can access the logical volume allocated to itself or the logical volume to which it has the right to access out of the logical volumes included in the storage subsystems, for reading and writing data. As an example of access control, an art is known in which a management server is disposed in the SAN and the management server is coupled to the respective host computers and the storage subsystems via a LAN (Local Area Network), according to which control can be performed integrally.

Further, the group of data used in the host computers executing various operations must be subjected to backup either periodically or non-periodically. The contents of the volumes of the host computers (host servers) for providing business services to the clients are copied to the host computers (backup servers) performing backup operation. Then, the contents of the volume copied to the backup servers are subjected to backup via backup devices such as optical disks and tape devices.

Further, for example, in order to perform backup of volumes of host servers, logical volumes (LUs) are respectively allocated to the host server and the backup server, and a copy pair composed of a primary volume acting as the copy source and a secondary volume acting as a copy destination is determined. Thereafter, volume copy is executed at an appropriate timing.

As described, an art related to setting or changing the storage configuration information in a management server when there are needs to change the configuration of the storage system arbitrarily in response to various needs is well known. For example, when the storage administrator changes the configuration of the storage system or the like, the change of configuration must be notified to respective administrators of the host computers sharing the storage via means such as telephones and emails. Further, since the configuration information retained by the respective host computers must also be changed arbitrarily along with the change of configuration of the storage system, administrators are required for the respective host computers for performing management operations. According to the described configuration, when it is necessary to set up or change the storage configuration information, the storage administrator must contact all the administrators of the related host computers, and the administrators of the respective host computers must perform the respective operations, according to which the operations for changing the settings of the storage configuration information become complex and take up much time.

One method for solving the above-described problem is an art taught in patent literature 1, wherein storage configuration information is set based on the orders from the management server.

### CITATION LIST

### Patent Literature

PTL 1: Japanese Patent No. 4,662,117 (U.S. Pat. No. 7,219,208)

### SUMMARY OF INVENTION

### Technical Problem

It requires a complicated process and takes up much time to set up or change the storage configuration information without using the management server according to the prior art described above. For example, if the storage administrator must change the configuration of the storage system or the like, it is necessary to notify the change of configuration to the administrator of the respective host computers sharing the storage using means such as telephones and emails.

Further, configuration information retained in each host computer must also be changed in order to cope with the change of configuration of the storage system, so that administrators for performing management operations are required for each host computer. As described, in order to set or change the storage configuration information, the storage administrator must communicate with the administrators of all the related host computers, and the administrators of the respective host computers must perform respective operations to cope with the change, according to which the operations for changing the settings of the storage configuration information becomes complex and takes up much time.

Patent literature 1 teaches an art of responding to the change of a logical configuration that does not accompany the change of a physical configuration, according to which the storage system composed of a host computer and a storage subsystem enables the host computer to automatically recognize the change of configuration of volumes mounted on and recognized by the host computer by the management server outputting a change command.

However, there have not been any references to an art of corresponding to cases such as the physical expanding/reducing/replacing of a storage subsystem physically, or the change of physical configurations such as the change of hardware configuration within the storage subsystem, by changing the type of the HDD as physical device, or expanding or replacing a controller for controlling the HDD.

Therefore, the object of the present invention is to provide a storage system and a method for managing the configuration information thereof, capable of automatically recognizing the change of configuration in a host computer side when change of logical configuration has occurred through the change of physical configuration, such as the expansion or reduction of the storage subsystems.

### Solution to Problem

In order to solve the problems mentioned above, the present invention provides allocation information of storage subsystems to the host computer side, wherein when storage subsystems are expanded or reduced, HDDs within the storage subsystem are expanded or reduced, or when physical change of hardware configuration has been executed, the execution of change of configuration and the contents of the change of configuration (contents of the change of logical configuration accompanying the physical change) are notified from the storage subsystem side to the host computer side, based on which the update of allocation information is executed automatically. Thereby, the host computer can constantly recognize the current appropriate configuration of one or more storage subsystems that it accesses.

Actually, when a storage system is newly configured, a coupling path information indicating the status of coupling between the host computers and the storage subsystems, a storage allocation information showing the status of allocation of the logical configuration of the storage subsystems with respect to the host computers and a storage coupling information being configured are created for each host computer. The created storage coupling information is stored in an internal storage device of each host computer. Then, when the configuration of the storage subsystem is changed, the changed storage allocation information or the coupling path information are transmitted to the corresponding host computer. In the host computer side, the update of the storage coupling information is executed automatically based on the received change contents. Thereby, the host computer can automatically recognize the configuration information of the storage subsystem.

### Advantageous Effects of Invention

According to the storage system of the present invention, when physical change of configuration is provided to the storage subsystem, the storage coupling information in the host computer can be updated automatically without requiring manual operation, so that the efficiency of maintenance management can be improved and human errors can be reduced. The problems, configurations and effects other than those described above are made clear by the following description of embodiments.

### BRIEF DESCRIPTION OF DRAWINGS

FIG. 1 is an explanatory view showing the overall configuration of a storage system and the concept of the present invention.

FIG. 2 is an explanatory view showing a configuration of the storage subsystem.

FIG. 3 is an explanatory view showing the relationship between a physical configuration and a logical configuration of a storage subsystem.

FIG. 4 is an explanatory view showing a storage allocation information.

FIG. 5 is an explanatory view showing a coupling configuration of the storage system.

FIG. 6 is an explanatory view showing a storage coupling information.

FIG. 7 is an explanatory view showing an FC coupling configuration information.

FIG. 8 is an explanatory view showing a storage configuration information.

FIG. 9 is an explanatory view showing a corresponding relationship between various information of a storage system.

FIG. 10 is a ladder chart showing the update processing of storage coupling information of the host computer via the storage subsystem.

FIG. 11 is a flowchart showing the configuration change processing in a storage subsystem.

FIG. 12 is a flowchart showing an update processing of a storage coupling information in a host computer.

FIG. 13 is an explanatory view showing a storage allocation information prior to changing the configuration of a storage subsystem.

FIG. 14 is an explanatory view showing a storage allocation information after changing the configuration of the storage subsystem.

FIG. 15 is an explanatory view showing a configuration of a CU configuration change information notice.

FIG. 16 is an explanatory view showing the storage coupling information updated via the CU configuration change information notice.

FIG. 17 is a flowchart showing the process for setting various configuration information of the storage system.

FIG. 18 is an explanatory view showing an overall configuration of the storage system according to embodiment 2.

FIG. 19 is an explanatory view showing a configuration of a CU configuration change information notice in storage subsystem a according to embodiment 2.

FIG. 20 is an explanatory view showing a configuration of a CU configuration change information notice in storage subsystem b according to embodiment 2.

### DESCRIPTION OF EMBODIMENTS

Now, the preferred embodiments of the present invention will be described with reference to the drawings. In the following description, various information are referred to as “tables” and the like, but the various information can be expressed by data structures other than tables. Further, the “tables” can also be referred to as “information” to indicate that the information does not depend on the data structure.

The processes are sometimes described using the term “program” as the subject. The program is executed by a MP (Micro Processor) or a CPU (Central Processing Unit) performing determined processes. The processors perform processes using appropriate storage resources (such as memories) and communication interface units (such as communication ports), so that the term processor can also be used as the subject of the processes. The processor can be equipped with a dedicated hardware in addition to the CPU. Computer programs can be installed to respective computers from a program source. The program source can be provided by a program distribution server or a storage media, for example.

Further, the various elements, such as controllers, can be identified via numbers, but other types of identification information such as names can be used as long as they are identifiable information. In the drawings and the description of the present invention, the same portions are denoted with the same reference numbers, but the present invention is not restricted to the illustrated embodiments, and various modifications in conformity with the ideas of the present invention are included in the technical scope of the present invention. Unless stated otherwise, the number of each element can be one or more than one.

### Embodiment 1

### Overall Configuration of Storage System, and Concept of Invention

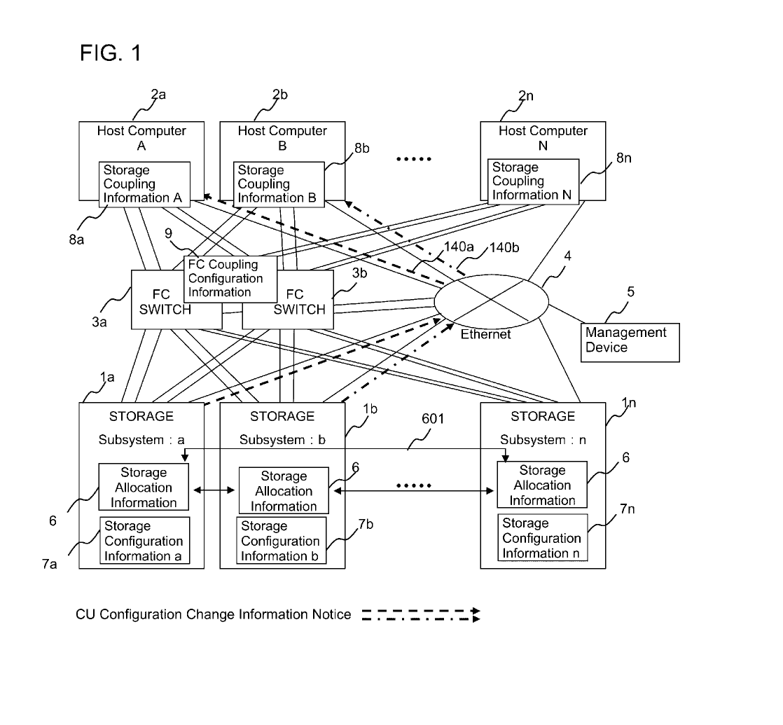

FIG. 1 is an explanatory view showing an overall configuration of a storage system, and the concept of the present invention. The storage system is composed of one or more host computers (hereinafter referred to as hosts) 2a, 2b . . . 2n (hereinafter also collectively referred to as host 2), one or more storage subsystems 1a, 1b . . . 1n (hereinafter also collectively referred to as storage subsystem 1), one or more FC switches 3a, 3b . . . (hereinafter also collectively referred to as FC switch 3) for coupling the host 2 and the storage subsystem 1 for enabling transmission and reception of commands and data, a network 4 for transmitting and receiving various configuration information (such as an Ethernet (Registered Trademark)), and a management terminal 5.

The storage subsystem 1a, 1b . . . 1n includes a storage allocation information 6 and storage configuration information 7a, 7b . . . 7n (hereinafter also collectively referred to as storage configuration information 7). The storage allocation information 6 is information indicating how each CU (Control Unit)/Device of each storage subsystem 1 is allocated to each host 2 throughout the whole storage system. The storage configuration information 7 is the configuration information for presenting a HDD (Hard Disk Drive) having a physical redundant configuration as a logical CU/Device. CU refers for example to an LU (Logical Unit), and the CU number corresponds to an LU number.

Furthermore, each host 2a, 2b . . . 2n includes storage coupling information 8a, 8b . . . 8n (hereinafter also collectively referred to as storage coupling information 8). The storage coupling information 8 is composed of an FC path information including a port information of the host 2 coupled before the FC switch 3 and a port information of the FC switch, and a storage mapping information which is a CU/Device information of the storage subsystem 1 coupled following the FC switch 3.

The FC switch 3 further stores an FC coupling configuration information 9. The FC coupling configuration information 9 is the coupling information of ports of the storage subsystem 1, the host 2 and the FC switch 3.

According to the present invention, the storage allocation information 6 is managed as a shared information among the respective storage subsystems 1. Each storage subsystem 1 creates the storage configuration information 7 of itself based on the storage allocation information 6. Further, storage coupling information 8 of each host is created from the storage allocation information 6 and the aforementioned FC coupling configuration information 9. The generated storage coupling information 8 is transmitted via the storage subsystem 1 to the corresponding host 2. The host 2 stores the transmitted storage coupling information 8 internally, as shown in FIG. 1.

If the configuration of a specific storage subsystem 1 (such as the storage subsystem a 1a) is changed (such as when a storage subsystem is expanded/deleted/replaced, or when a device is expanded/deleted/replaced/changed), the storage allocation information 6 is first updated. The storage allocation information 6 updated via a specific storage subsystem 1 retains the identical information within each storage subsystem 1 by transmitting information to the other storage subsystems 1 (for example, to the storage subsystem n 1n) or by referring to other storage subsystems 1, as shown in reference number 601. As described, each of the respective storage subsystems 1 retains shared information on the allocation of the respective CUs/Devices of the storage subsystems 1 to each of the hosts 2.

In the storage subsystem 1, the host 2 using the CU/Device changing its physical configuration creates a storage coupling information 8 based on the updated storage allocation information 6, and transmits the information as a CU configuration change information notice mentioned later to a corresponding host 2. In the host 2, the contents of the storage coupling information 8 stored therein are updated automatically based on the received CU configuration change information notice. Similarly, when the configuration of the FC switch 3 is changed by adding a host 2 or a storage subsystem 1, in other words, when FC coupling information 9 is changed, the storage coupling information 8 is updated based on the changed contents and the information is sent to a corresponding host as CU configuration change information notice. As described, the storage coupling information 8 in the host is updated automatically.

Since the storage allocation information 6 is shared among the storage subsystems 1, when CU configuration is updated at any one of the storage subsystems, it becomes possible to recognize the update by the other storage subsystems 1. Therefore, even when the physical configurations of two or more storage subsystems are changed, the correct CU configuration can be recognized by the host 2 by changing the CU configuration of the storage subsystem 1 sequentially.

Further, the sharing of the storage allocation information 6 can be performed by using the network 4 such as an Ethernet, or by providing a dedicated command in the FC (Fibre Channel) to send and receive information via the FC switch 3. Furthermore, the change of configuration of multiple storage subsystems 1 should be performed one at a time, not simultaneously, in order to maintain the consistency of the storage allocation information 6.

As described, when the coupling information to the storage subsystems 1 is provided to the host 2 side, and the change of hardware configuration such as the expansion or reduction of the storage subsystem 1, the expansion or reduction of devices such as the HDD within the storage subsystem 1 or the controllers is executed, the addition of information and the contents of the change of configuration are sent from the storage subsystem 1 to the host 2 side, and the update of coupling information to the storage subsystem 1 is executed. Thereby, the host 2 can constantly recognize the appropriate current configuration of the one or more storage subsystems that it accesses. Further, the storage subsystems 1 may be arranged in a dispersed manner at physically distant locations, and the update operation can be performed at respective locations where the storage subsystems 1 are arranged.

<Internal Configuration of Storage Subsystem>

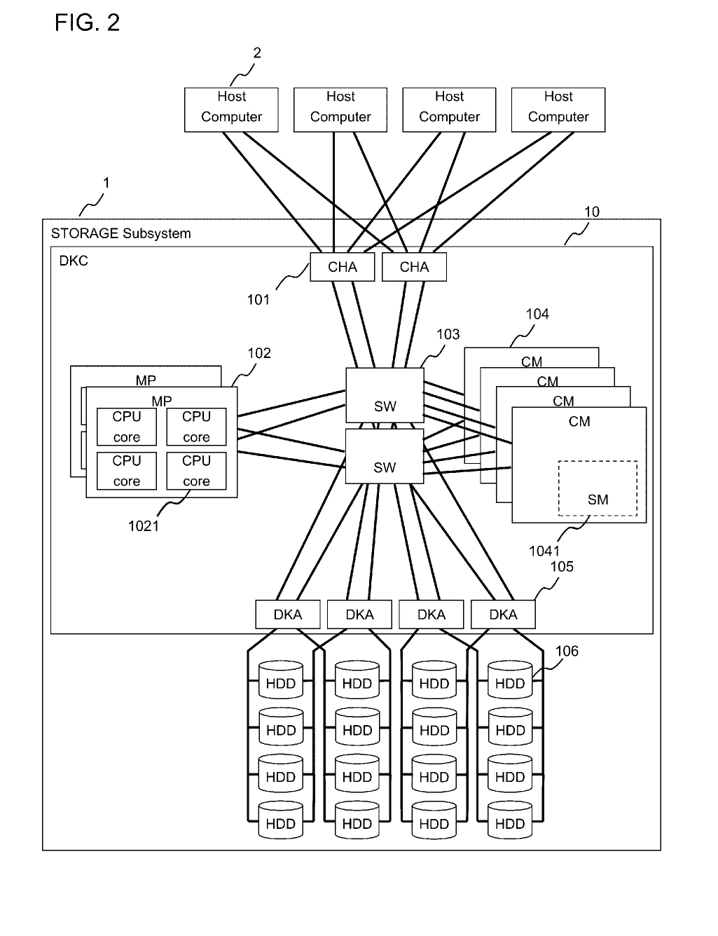

FIG. 2 is an explanatory view showing the configuration of a storage subsystem. The storage subsystem has a function to emulate a specific HDD (Control Unit/Device) to the host 2 using the storage configuration, the processor and the cache memory.

The storage subsystem 1 is coupled to one or more hosts 2 via CHAs (Channel Adaptors) 101 of DKCs (Disk Controllers) 10. Further, the storage subsystem 1 comprises multiple physical devices 106, and DKAs (Disk Adaptors) 105 coupled to the multiple physical devices.

The multiple physical devices 106 include, for example, SSDs (Solid State Drives) and HDDs. HDDs include FC (Fibre Channel) type devices, SAS (Serial Attached SCSI) type devices, and SATA (Serial ATA) type devices.

Further, the same type of HDD may have different capacities and number of rotations. For example, the SAS type HDDs can be classified into a high performance type (number of rotations: 15 Krpm (rotation per minute), 146 GB), a normal type (number of rotations: 10 Krpm, 900 GB), and a NL (Near Line) type having low access performance but is inexpensive and has high capacity (number of rotations: 7.2 Krpm, 1/2/3 TB).

The DKC 10 has multiple CHAs 101, multiple DKAs 105, multiple CM (Cache Memory) boards 104, multiple MP (Micro Processor) boards 102, and multiple SWs (Switches) 103.

Multiple numbers of CHAs 101, MP boards 102, SWs 103, CM boards 104 and DKAs 105 exist from the viewpoint of redundancy, but the number of at least one of these components can be one, or more than three.

The CHA 101 is an interface unit coupled to the host 2. The CHA 101 receives an I/O command (write command or read command) from the host 2, and transfers the received I/O command to any one of the multiple MP boards 102.

The DKA 105 reads data from the physical devices 106 and transfers the same to the SM (Shared Memory) 1041 on the CM board 104, or writes the data sent from the SM 1041 to the physical devices 106.

The MP board 102 is a control unit having one or more CPU (Central Processing Unit) cores (hereinafter referred to as CPU) 1021. The CPU 1021 processes I/O commands from the CHA 101.

The SWs 103 have CHAs 101, DKAs 105, CM boards 104 and MP boards 102 coupled thereto, and controls the couplings among the respective adapters or packages.

The CM boards 104 are storage devices including a volatile memory such as a DRAM (Dynamic Random Access Memory) and/or a nonvolatile memory such as a flash memory. The CM boards 104 stores, for example, various configuration information, programs and data.

Each storage subsystem 1 has a management device 5 coupled thereto via a network 4 as shown in FIG. 1, but it is also possible to have the management device 5 directly coupled to the storage subsystem 1. The internal configurations of the host 2 and the management device 5 are not illustrated, but each component is equipped with a CPU, a memory, a storage disk, a pointing device such as a mouse, an input device such as a keyboard, an output device such as a display, and a communication interface, which are mutually coupled via an internal bus. Further, the management device 5 receives various settings of the storage subsystems 1, and displays the configuration information and the status of operation of the storage subsystems 1 or the storage coupling information 8 stored in the host 2 described later.

<Correspondence between Physical Configuration and Logical Configuration>

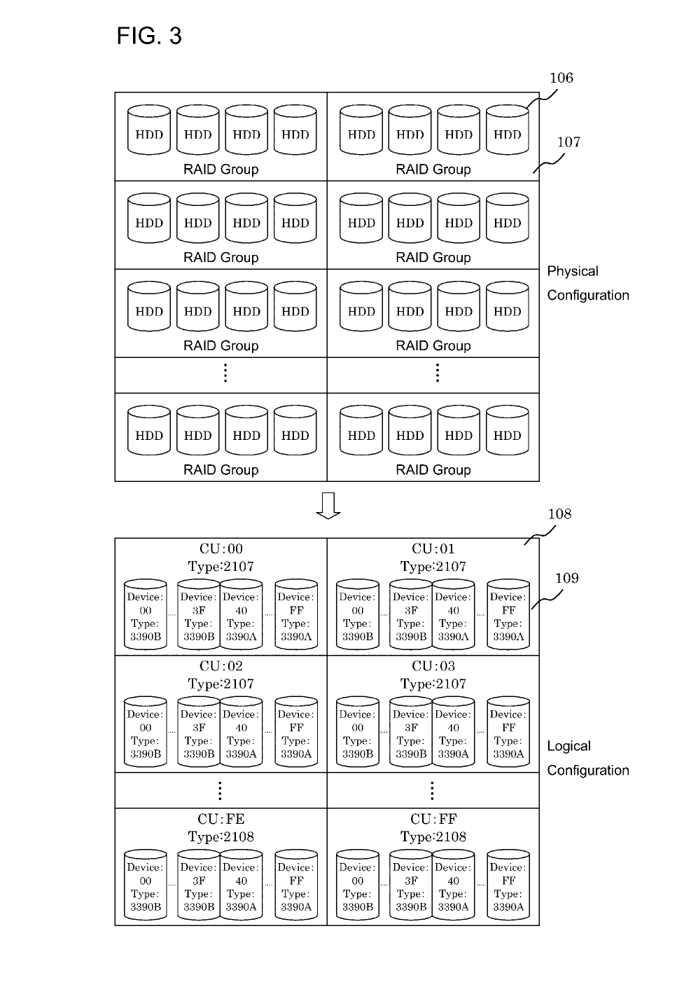

FIG. 3 is an explanatory view showing the relationship between a physical configuration and a logical configuration of the storage subsystem. The storage subsystem has an emulation function in which a physical configuration composed of RAID (Redundant Array of Independent Disks) groups 107 composed of multiple HDDs 106 is converted to a logical configuration composed of CUs 108/Devices 109. The storage subsystem 1 provides the CU 108/Device 109, which is an emulated logical configuration, to the host 2.

The CUs 108/Devices 109 are composed of information including CU ID, CU Type, Device ID and Device Type.

The CU ID is information for uniquely identifying the controllers. It is common to use a continuous serial numbers, which are the CU logical numbers within the storage subsystem.

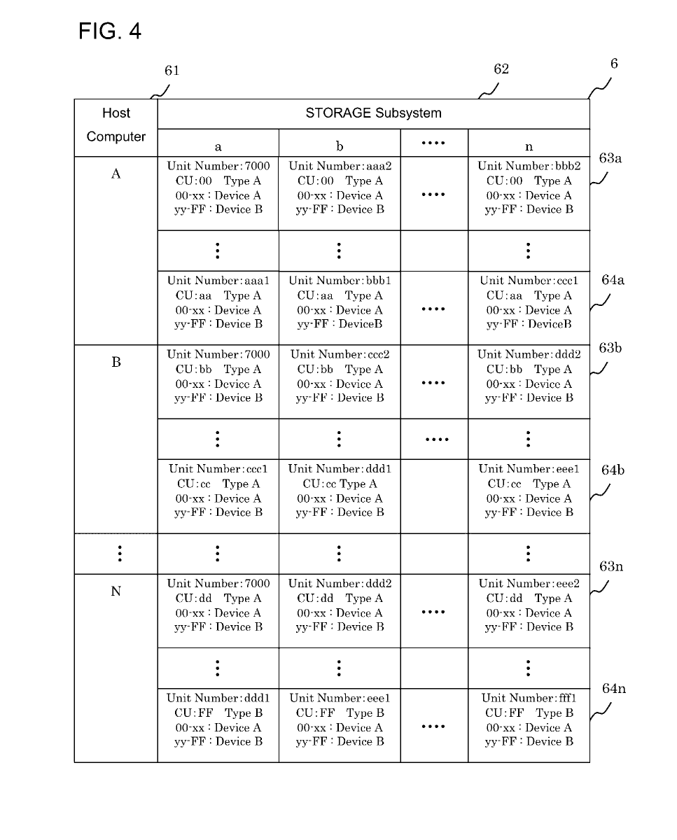

The CU Type is information for indicating the type of the controller. For example, a controller denoted as “Type: 2107” represents a relatively expensive controller having an FC interface and a SAS interface. A controller denoted as “Type: 2108” represents a relatively inexpensive controller having only a SAS interface. Further, as shown in FIG. 4, “Type: 2107” can be referred to as “Type A” and “Type: 2108” can be referred to as “Type B”, using alphabets instead of numbers.

The Device ID is information for identifying the physical devices such as HDDs. In general, the Device IDs are continuous serial numbers (logical numbers) assigned to the respective physical devices of the CU. For example, in a CU having a CU ID “00”, a number “00-3F” is allocated as a serial number (logical number) to a physical device in which the Device Type is “3390B”, and a number “40-FF” is allocated as a serial number (logical number) to a physical device in which the Device Type is “3390A”.

The Device Type is information representing the type of the physical device. For example, the device denoted as “Type: 3390A” refers to a 1-TB SAS type HDD, and the device denoted as “Type: 3390B” refers to a 2-TB SATA type HDD. Further, as shown in FIG. 4, it is possible to use alphabets instead of numbers to refer to the device, such as “Device A” instead of “Type: 3390A”, as shown in FIG. 4.

The above-described CU/Device configuration information is applied to the storage allocation information described later, to enable the storage subsystem to identify the allocation of CU and Device of the respective storage subsystems to the respective logical addresses of the hosts.

<Storage Allocation Information>

FIG. 4 is an explanatory view showing a storage allocation information. The storage allocation information 6 is configuration information for identifying the allocation of the CUs and Device of the storage subsystems to the logical address spaces of the hosts.

The storage allocation information 6 is composed of a host information 61, a storage subsystem information 62, logical configuration information 63a/64a, 63b/64b . . . 63n/64n (hereinafter also collectively referred to as logical configuration information 63 or 64). The logical configuration information 63 is composed by adding a Unit Number, which is the information on a logical address space allocated in the host 2, to the configuration information of the CU 108/Device 109.

For example, a logical address space starting from Unit Number “7000” in a host in which the host information 61 is “A” has allocated thereto a device in which the Device ID is “00-xx” and Device Type is “A” and a device in which the Device ID is “yy-FF” and Device Type is “B” of the CU in which the CU ID is “00” and the CU Type is “A” of the storage subsystem a in which the storage subsystem information 62 is “a”. Allocation is performed in a similar manner for the address spaces starting from Unit Number “aaa1”.

Allocation is performed similarly in the case of host A and storage subsystem b, and of host A and storage subsystem n. Hosts B and N can be allocated similarly as in the case of host A.

<Coupling Configuration of Device>

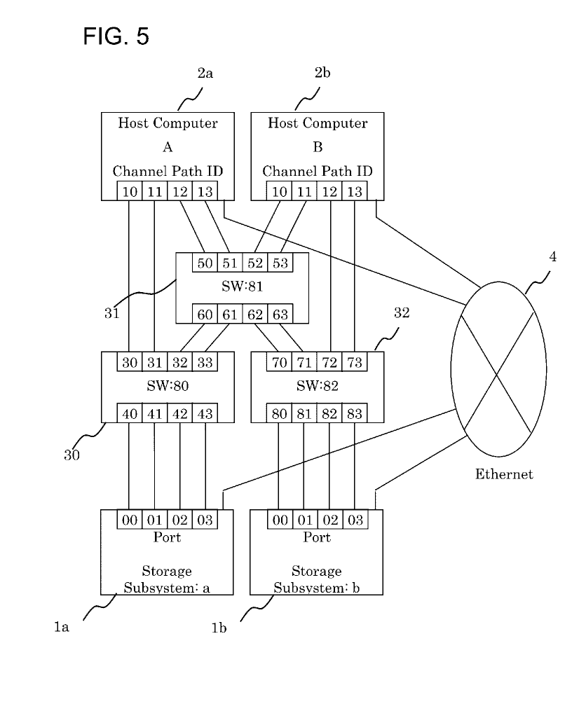

FIG. 5 is an explanatory view showing a coupling configuration of the storage system. FIG. 5 illustrates a configuration in which the storage subsystems 1 and the hosts 2 are coupled via FC switches 30, 31 and 32.

For example, a port having a Channel Path ID “10” of host A 2a is coupled to a port having a Port ID “30” of the FC switch 30 (SW ID: 80). Further, a port having a Port ID “40” of the FC switch 30 (SW ID: 80) is coupled to a port having a Port ID “00” of the storage subsystem a 1a. In other words, it can be seen that the host A 2a and the storage subsystem a 1a are coupled via the FC switch 30.

Similarly, a port having a Channel Path ID “12” of host B 2b is coupled to a port having a Port ID “72” of the FC switch 32 (SW ID: 82). Further, a port having a Port ID “82” of the FC switch 32 (SW ID: 82) is coupled to a port having a Port ID “02” of the storage subsystem b 1b. In other words, it can be seen that the host B 2b and the storage subsystem b 1b are coupled via the FC switch 32.

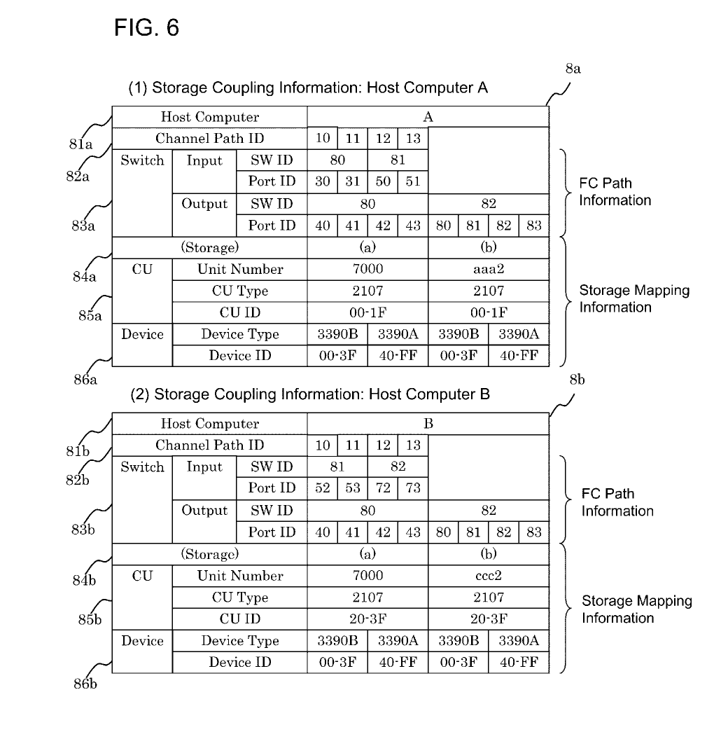

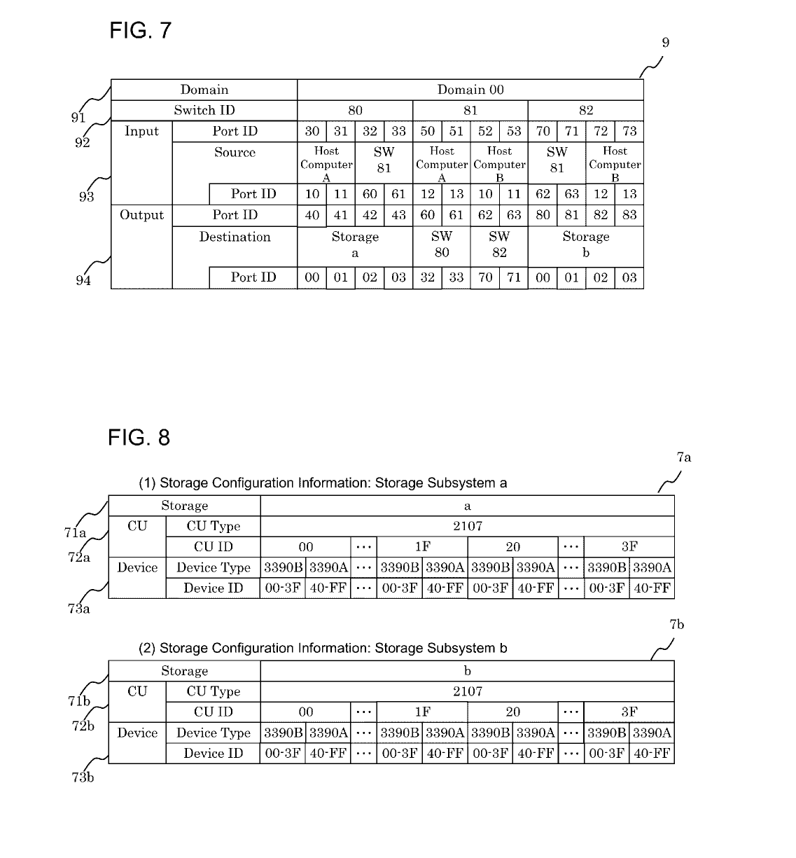

The above-described coupling information between the FC switch 3 and the storage subsystem 1 or the host 2, or among FC switches 3, is managed as FC coupling configuration information 9 (FIG. 7) by the FC switch 3, and acquired by the storage subsystem 1 via the network 4. Based on the FC coupling configuration information 9, the coupling between the respective hosts and storage subsystems and the paths (switches) through which they are coupled can be seen. The FC coupling configuration information 9 is utilized as a FC path information in the storage coupling information 8 (FIG. 6) described later. The FC coupling configuration information 9 will not be changed unless the storage subsystem 1 or the host 2 are expanded or deleted.

<Storage Coupling Information>

FIG. 6 is an explanatory view showing a storage coupling information.

The storage coupling information 8 is composed of a FC path information composed of the port information of the host 2 coupled before the FC switch 3 and the port information of the FC switch, and a storage mapping information which is the CU/Device information of the storage subsystem 1 coupled following the FC switch 3. The storage coupling information 8a/8b respectively include host information 81a/81b, Channel Path ID 82a/82b, FC switch information 83a/83b, storage information 84a/84b, CU information 85a/85b, and Device information 86a/86b.

The FC switch information 83a/83b corresponds to the FC path information, and the storage information 84a/84b, the CU information 85a/85b and the Device information 86a/86b correspond to the storage mapping information.

Further, the CU information 85a/85b includes the Unit Number, the CU Type and the CU ID described in FIGS. 3 and 4. The Device information 86a/86b include the Device ID and Device Type described in FIGS. 3 and 4.

According to the present embodiment, as described with reference to FIG. 5, host A and host B are respectively coupled to each of the storage subsystems a and b, so that storage coupling information 8 is created for each host 2. Then, the storage coupling information 8a is stored to host A 2a as “storage coupling information A”, and the storage coupling information 8b is stored to host B 2b as “storage coupling information B”

<FC Coupling Configuration Information>

FIG. 7 is an explanatory view showing a FC coupling configuration information. The FC coupling configuration information 9 includes a Domain information 91, a Switch ID 92, an input-side port information 93, and an output-side port information 94.

The Domain information 91 is information for uniquely identifying the groups of the FC switch.

The Switch ID (SW ID) 92 is information for uniquely identifying each FC switch.

The input-side port information 93 is composed of an input Port ID of the FC switch, the coupling source and the coupling port information. For example, it can be recognized based on the FC coupling configuration information 9 that port 30 (Port ID “30”) of SW 80 (Switch ID 92 “80”) is coupled to port 10 of host A 2a. Similarly, port 73 of SW 82 is coupled to port 13 of host B 2b.

An output-side port information 94 is composed of an output Port ID of the FC switch, a coupling destination and a coupling port information. For example, it can be recognized based on the FC coupling configuration information 9 that port 40 (Port ID “40”) of SW 80 (Switch ID 92 “80”) is coupled to port 00 (Port ID “00”) of the storage subsystem a 1a. Similarly, port 83 of SW 82 is coupled to port 03 of the storage subsystem b 1b.

Based on the FC coupling configuration information 9, the storage system is capable of recognizing the status of mutual coupling between the storage subsystems 1, the hosts 2 and the switches 3, as shown in FIG. 5.

<Storage Configuration Information>

FIG. 8 is an explanatory view showing the storage configuration information. The storage configuration information 7 includes storage information 71a/71b for identifying the storage subsystems, CU information 72a/72b, and Device information 73a/73b. Further, the CU information 72a/72b include the information on the CU ID and the CU Type described with reference to FIGS. 3 and 4. The Device information 73a/73b also include the information on the Device ID and the Device Type described with reference to FIGS. 3 and 4.

Based on the storage configuration information 7, the storage system can recognize the logical configuration of the storage devices of the storage subsystems 1 provided to the hosts 2.

<Corresponding Relationship of Information>

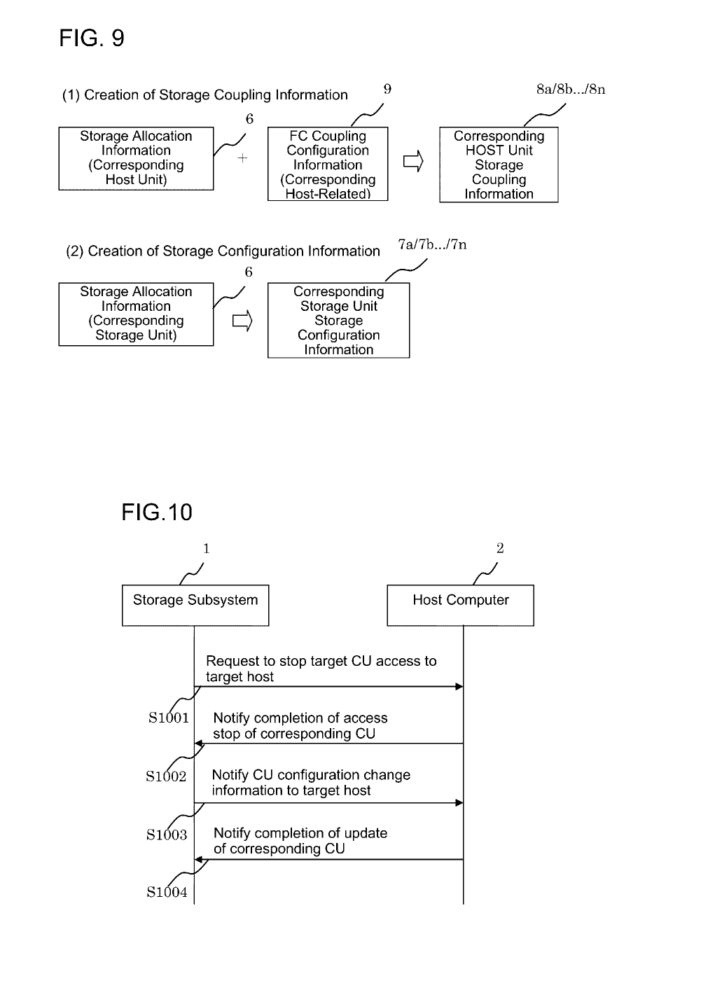

FIG. 9 is an explanatory view showing the corresponding relationship between various information of the storage system. The corresponding relationship of the storage allocation information 6, the storage coupling information 8, the FC coupling configuration information 9 and the storage configuration information 7 will be described with reference to FIG. 9.

The storage subsystem 1 can create the storage coupling information 8 illustrated in FIG. 6 using the storage allocation information 6 illustrated in FIG. 4 and the FC coupling configuration information 9 illustrated in FIG. 7.

At first, in order to create storage coupling information A 8a of host A 2a, the storage subsystem a 1a extracts the logical configuration information 63a/64a in which the host information 61 is “A” from the storage allocation information 6. In other words, the storage subsystem a 1a extracts the logical configuration information of the storage subsystem 1 allocating the logical device to the host A 2a.

Next, the storage subsystem a 1a acquires the FC coupling configuration information 9 from the FC switch 3. Then, the storage subsystem a 1a creates storage coupling information A 8a of the host A 2a from the extracted logical configuration information and the acquired FC coupling configuration information 9. Then, the storage subsystem a 1a transmits the generated storage coupling information A 8a to the host A 2a when the information is set. The storage subsystem a 1a executes the same operations starting from host B 2b to host N 2n. The same operations are also executed in storage subsystems b 1b to n In regarding hosts A 2a to N 2n. Thereby, the respective hosts 2 can recognize the allocation of the CUs/Devices of the respective storage subsystems 1.

Further, the storage configuration information 7 is created by the respective storage subsystems 1 extracting the information related to itself from the storage allocation information 6. For example, the storage subsystem a 1a extracts the logical configuration information of the storage device with respect to each host 2 of the column where the storage subsystem information 62 is “a”.

<Update Processing of Configuration Information/Coupling Information>

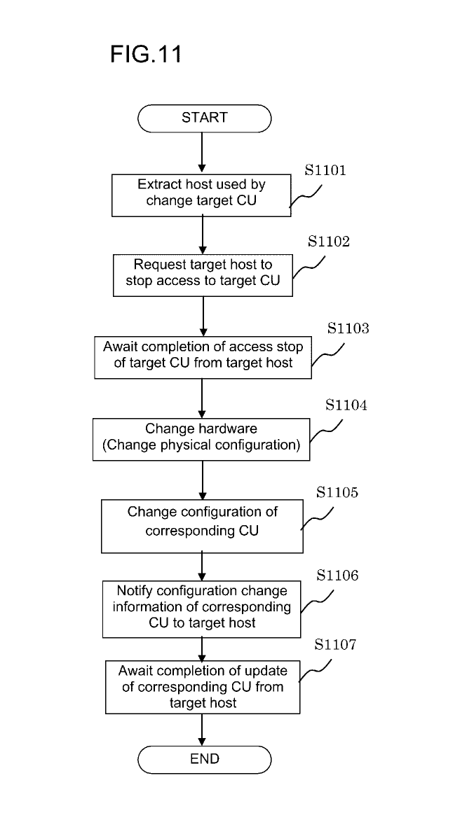

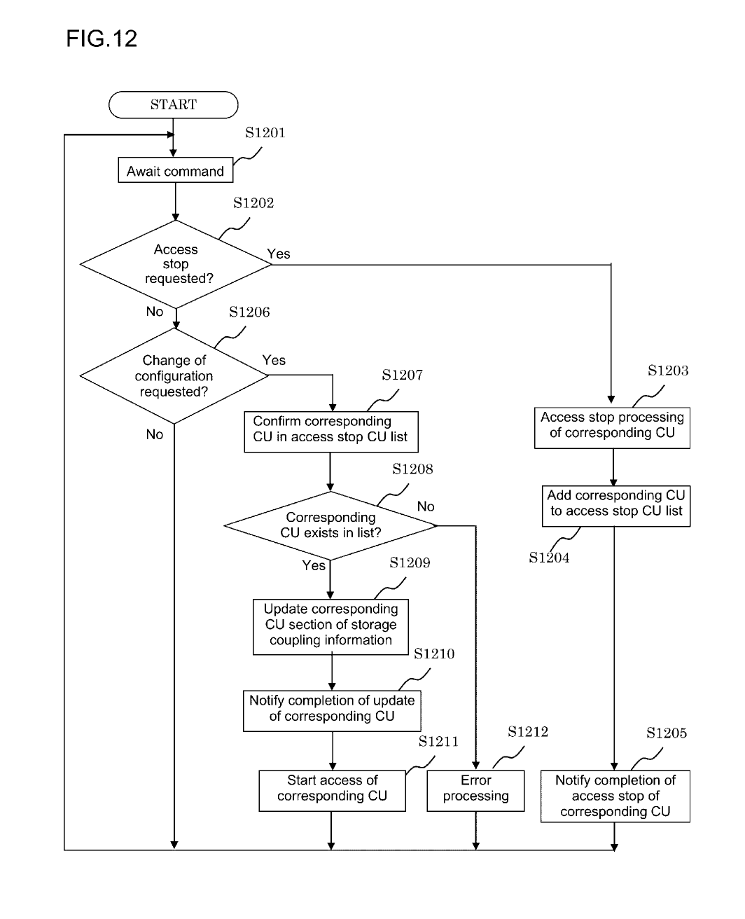

FIG. 10 is a ladder chart showing the update processing of the storage coupling information of the host via the storage subsystem. FIG. 11 is a flowchart showing the configuration change processing in the storage subsystem. FIG. 12 is a flowchart showing the update processing of the storage coupling information in the host. In the following description, the system is described as the subject of processing, but it is also possible to have a software resource such as a control program in the system or a hardware resource such as a CPU in which the control program is executed set as the subject of processing.

Next, the update processing of the configuration information/coupling information is described with reference to FIGS. 10 through 12. The update processing of the configuration information/coupling information is started when the configuration of the storage subsystem 1 is changed (such as when the capacity is increased or decreased (the number of storage devices is increased or decreased), or when the number of CUs is increased or decreased), or when the coupling of the FC switch is changed, for example.

In order to simplify the description, the storage subsystems performing change of CU are the storage subsystem a 1a and the storage subsystem b 1b, wherein both the storage subsystem a 1a and the storage subsystem b 1b allocate CUs to both the host A 2a and host B 2b. Further, it is assumed that the CU to be allocated to host A 2a in the storage subsystem a 1a and the CU to be allocated to host B 2b in the storage subsystem b 1b.

At first, the storage subsystem 1 extracts the host 2 (target host 2) to which the CU being the target of change of configuration is allocated. Then, the storage subsystem 1 sends a request to stop accesses to the CU being the target of change of configuration (target CU) to the target host 2 (S1001).

Next, the target host 2 stops accesses to the target CU to which the access stop request has been issued, and transmits a CU access stop completion notice to the storage subsystem 1 (S1002).

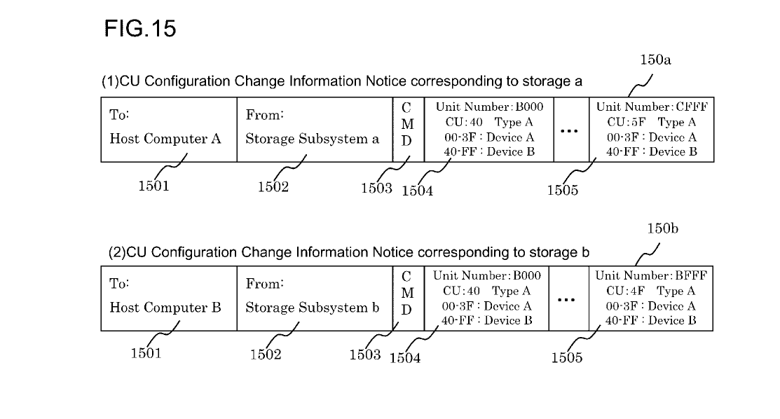

Next, the storage subsystem 1 transmits a CU configuration change information notice (FIG. 15) notifying the contents of change of CU configuration to the target host 2 (S1003).

Lastly, the target host 2 having received the CU configuration change information notice updates the storage coupling information 8 corresponding to the CU having the configuration changed, cancels the stopping of accesses to the CU, and transmits a CU update complete notice to the storage subsystem 1 (S1004).

The above-described update processing is first executed by the storage subsystem a 1a to the host A 2a. After completing the update processing of the host A 2a, the storage subsystem b 1b executes the update processing to host B 2b. Moreover, the storage configuration information 7a/7b is respectively changed in the storage subsystem a 1a and the storage subsystem b 1b via the updated storage subsystem allocation information 6. Further, the CUs other than the CU having its configuration changed are set to states enabling continuous execution of accesses. Further, in order to maintain the consistency of configuration information and coupling information, the update processing of the configuration is performed for one storage subsystem at a time.

<Configuration Change Processing in Storage Subsystem>

Next, the aforementioned process of changing the CU configuration in the storage subsystem will be described with reference to FIG. 11.

At first, in S1101, the storage subsystem a 1a extracts the host utilizing the CU being the change target (target CU). In the present example, the CU to be utilized by the host A 2a is added to the storage subsystem a 1a, so that the storage subsystem a 1a extracts host A 2a as the target host.

Next, in S1102, the storage subsystem a 1a sends an access stop request of the target CU to the host A 2a (target host).

In S1103, the storage subsystem a 1a awaits an access stop completion notice from the host A 2a regarding the target CU. When the access stop complete notice of target CU from the host A 2a is received by the storage subsystem a 1a, the storage subsystem a 1a executes S1104.

In S1104, the storage subsystem a 1a executes change of hardware (change of physical configuration), that is, expands a CU.

In S1105, the storage subsystem a 1a updates the configuration information of the section corresponding to the storage allocation information 6 by the configuration information related to the CU being expanded. After update of the storage allocation information 6 has been completed, the storage subsystem a 1a updates its own storage configuration information 7a.

The updated storage allocation information 6 retains consistency by transmitting information to other storage subsystems from the storage subsystem in which update has occurred, as shown by reference number 601 of FIG. 1, and storing the same information. According to another example, the storage subsystem can periodically acquire the storage allocation information of the storage subsystems other than itself periodically, compare the acquired storage allocation information with the storage allocation information stored in itself, and if there is any difference, update the storage allocation information stored in itself.

Next, in S1106, the storage subsystem a 1a transmits a CU configuration change information notice (reference number 150a of FIG. 15) to the host A 2a.

In S1107, the storage subsystem a 1a awaits reception of update complete notice of the corresponding CU from the host A 2a. In host A 2a, the storage coupling information A 8a is updated via the received CU configuration change information notice. After completing update of the storage coupling information A 8a, the host A 2a transmits an update complete notice of the corresponding CU to the storage subsystem a 1a. When the storage subsystem a 1a receives an update complete notice of the corresponding CU from the host A 2a, the update processing of configuration information and coupling information are ended.

The storage subsystem b 1b executes the above-described processes to host B 2b, and updates the configuration information and coupling information.

<Change of CU Configuration in Host>

Next, the above-described update processing of the storage coupling information 8 performed in host 2 will be described with reference to FIG. 12. The present process is operated constantly via an agent or the like of the host 2, which awaits a request command (hereinafter referred to as command) from the storage subsystem 1 and performs processes in response to the received command. In such agent processing, the CU being the update target (corresponding CU) is managed via a list so as not to perform undue update of the CU.

In S1201, the host A 2a awaits commands from the storage subsystem 1. The command can be a CU access stop request in S1001 of FIG. 10 or the CU configuration change information notice of S1003, for example. When a command from the storage subsystem 1 is received, the host A 2a executes the process of S1202. In the present example, the command from the storage subsystem a 1a is transmitted to the host A 2a.

In S1202, the host A 2a determines whether the command from the storage subsystem a 1a is an access stop request to a CU. If the command is an access stop request to the CU (S1202: Yes), the host A 2a executes S1203, and if the command is not an access stop request (S1202: No), the host A 2a executes S1206. That is, if the request is a target CU access stop request from the storage subsystem a 1a of S1001 in FIG. 10, the host executes S1203.

In S1203, the host A 2a executes an access stop processing to the CU corresponding to the access stop request. That is, receiving of a new CU access request is prohibited, and after all accesses in execution are completed, the accesses to the CU are stopped.

Next, in S1204, the host A 2a adds the information of the CU to which access has been stopped (such as the CU ID (logical address) and the like) to an access stop CU list.

In S1205, the host A 2a transmits a CU access stop complete notice to the storage subsystem a 1a. This process corresponds to the process of S1002 in FIG. 10. After processing in S1205 is completed, the host A 2a re-executes the process of S1201, and awaits reception of a subsequent command.

In S1201, the host A 2a receives a CU configuration change information notice (S1003 of FIG. 10) from the storage subsystem a 1a. The current command is not a CU access stop request, so the host A 2a executes S1206.

In S1206, the host A 2a determines whether the command from the storage subsystem a 1a is a CU configuration change request (CU configuration change information notice). If the command is a CU configuration change request (S1206: Yes), the host A 2a executes S1207, and if it is not a CU configuration change request (S1206: No), the host re-executes S1201.

In S1207, the host A 2a confirms whether the CU information in the CU configuration change request (corresponding CU) exists in the access stop CU list or not.

In S1208, the host A 2a executes S1209 if the corresponding CU exists in the access stop CU list (S1208: Yes), and executes the error processing of S1212 if not (S1208: No). According to the present error processing, the reception of an undue CU update request is notified to the host 2 and the management device 5, and a warning is output to the user or the administrator. As described, by confirming whether the corresponding CU in the CU configuration change request exists in the access stop CU list or not, it becomes possible to prevent update based on an undue CU information with respect to the storage coupling information 8.

In S1209, the host A 2a extracts the CU configuration change information of the corresponding CU section from the CU configuration change information notice, and updates the storage coupling information 8 using the extracted CU configuration change information.

In S1210, the host A 2a sends a corresponding CU update complete notice to the storage subsystem a 1a. This process corresponds to S1004 of FIG. 10.

Lastly, in S1211, the host A 2a cancels the stopping of access to the corresponding CU, and permits starting of accesses. Then, the host A 2a re-executes the process of S1201.

As described above, according to the present invention, an allocation information of the storage subsystem 1 is provided to the host side 2, and when expansion/reduction of the storage subsystems, expansion/reduction of the storage devices (physical devices) such as the HDDs within the storage subsystem or the change of hardware configuration are performed, a notice that configuration has been changed and the contents of the change of configuration are notified from the storage subsystem 1 side to the host 2 side, based on which the update of allocation information of the storage subsystem 1 can be executed automatically. Thus, the host 2 can constantly recognize the current appropriate logical configuration of the one or more storage subsystems 1 that the host 2 accesses.

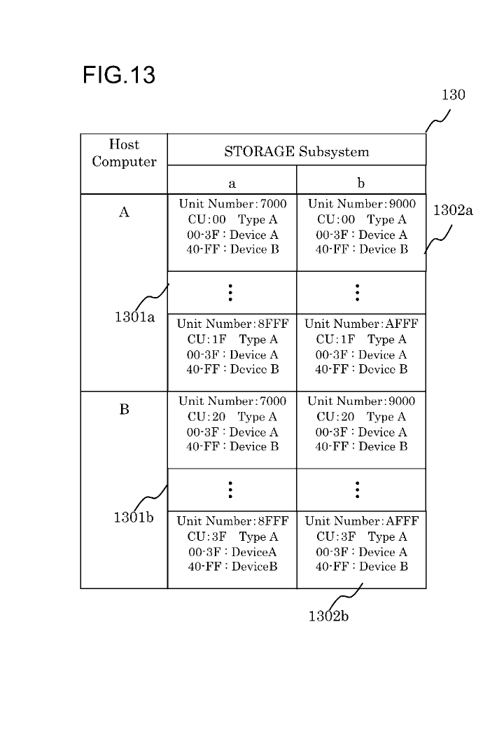

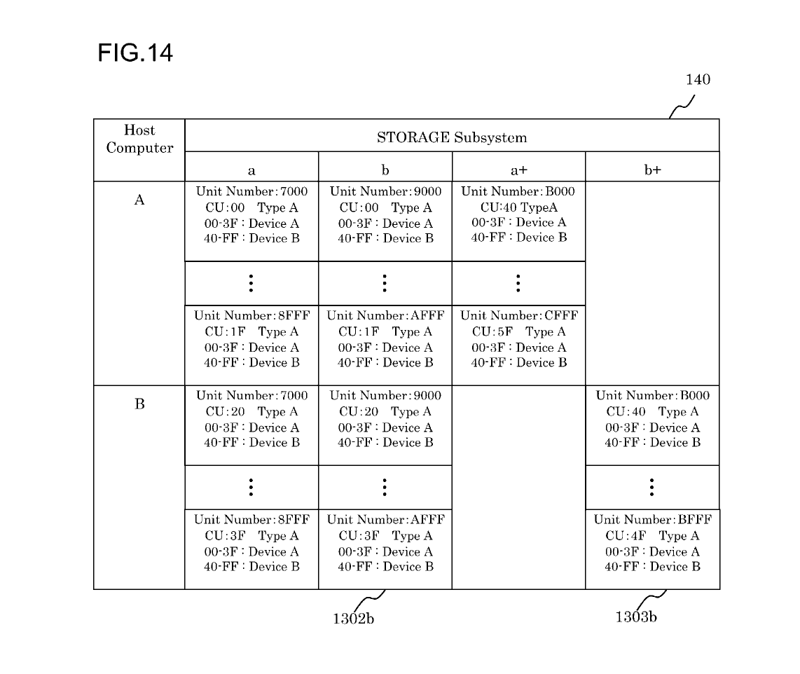

FIG. 13 is an explanatory view showing a storage allocation information prior to changing configuration of the storage subsystem. FIG. 14 is an explanatory view showing the storage allocation information after changing configuration of the storage subsystem.

FIG. 13 illustrates the contents of the storage allocation information 130 with respect to the host a 2a and host b 2b prior to changing the configurations of the storage subsystem a 1a and the storage subsystem b 1b. For example, reference number 1301a refers to the storage allocation information of the storage subsystem a 1a allocated to the host a 2a.

FIG. 14 shows a storage allocation information 140 after adding a CU to the configuration of the storage subsystem 1 of FIG. 13 described above. In other words, a configuration example of a storage allocation information is illustrated in which a CU for host A 2a is added to the storage subsystem a 1a and a CU for host B 2b is added to the storage subsystem b 1b. The arrow represents the seriality of the logical numbers of the CUs within the storage subsystem and the seriality of the logical address within the host.

FIG. 15 is an explanatory view showing a configuration of a CU configuration change information notice. Regarding the change of CU configuration described above, the storage subsystem a 1a sends a CU configuration change information notice 150a to the host A 2a, and requests update of the storage coupling information A 8a. Similarly, the storage subsystem b 1b sends a CU configuration change information notice 150b to the host B 2b, and requests update of the storage coupling information B 8b. In the following description, the CU configuration change information notice 150a/150b may be collectively referred to as CU configuration change information notice 150.

The CU configuration change information notice 150a/150b includes a notice destination 1501, a notice source 1502, a notice command 1503, and a content of notice 1504/1505. The notice destination 1501 stores the host information for executing the change of CU configuration, and the notice source 1502 stores the information on the storage subsystem requesting the change of CU configuration.

The notice command 1503 stores the information representing the expansion/reduction/change of CU or Device. That is, if a CU has been reduced, the host 2 side will only simply recognize that a CU that has been accessed before cannot be accessed now. Therefore, the host 2 cannot determine whether incapable access was caused by the reduction of the storage subsystem 1 or by failure.

Therefore, when a storage subsystem 1 is reduced, the information of reduction is stored in the CU configuration change information notice of the host 2, in other words, “reduction” is stored in the notice command 1503. Thereby, the host 2 can recognize that the cause of access incapability to the storage subsystem 1 is not “failure” but the “reduction of the storage subsystem”, according to which the number of maintenance steps can be cut down and the efficiency of maintenance can be enhanced.

Furthermore, if access to the reduced CU occurs from the host 2 to the storage subsystem 1 even when “reduction” is notified via the CU configuration change information notice, the cause of access incapability (CU reduction) is transmitted from the storage subsystem 1 to the host 2 or the management device 5, according to which the user or the administrator can recognize the malfunction and the cause thereof, so that the maintenance performance is enhanced.

The content of notice 1504/1505 stores the CU configuration change information corresponding to the notice command 1503. In the present example, the change is the addition of a CU, so that the notice command 1503 stores “expansion”, and the content of notice 1504/1505 of the CU configuration change information notice 150a stores the logical address information (Unit Number) within the host A 2a and the CU configuration change information including the CU ID, the CU Type, the Device ID and the Device Type being added. The content of notice 1504/1505 of the CU configuration change information notice 150b stores the CU configuration change information to the host B 2b. This content of notice 1504/1505 corresponds to the storage mapping information of the storage coupling information 8 (FIG. 6).

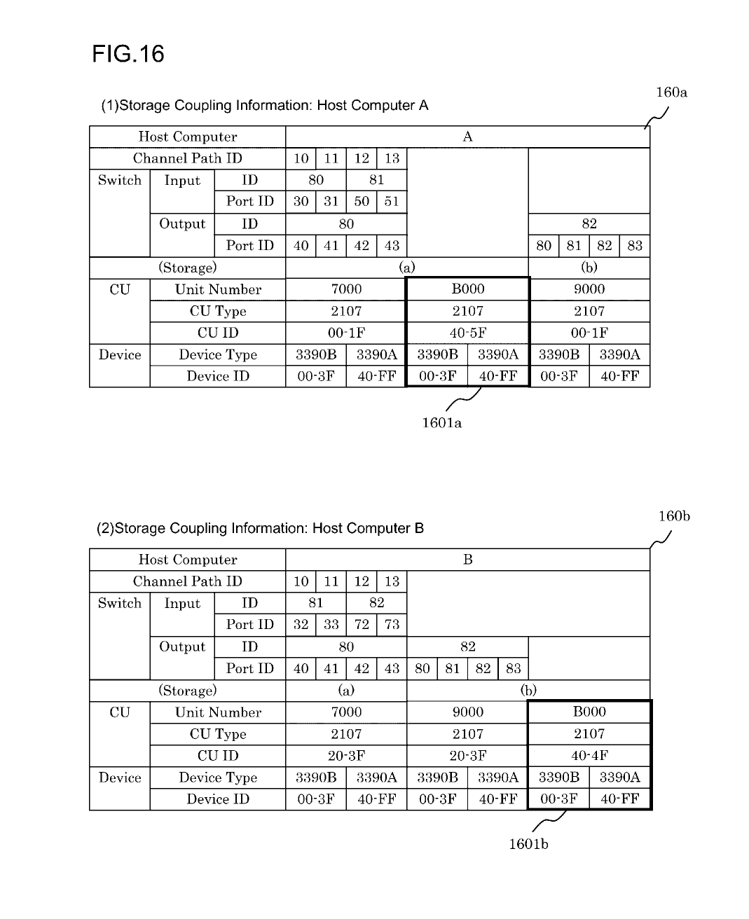

FIG. 16 is an explanatory view showing the storage coupling information updated via the CU configuration change information notice. Based on the CU configuration change information notice 150a to the host A 2a from the storage subsystem a 1a, CU and Device information referred to by reference number 1601a is added to the storage coupling information A 8a of host a 2a (the state of reference number 160a). Similarly, based on the CU configuration information notice 150b from the storage subsystem b 1b to the host B 2b, CU and Device information referred to by reference number 1601b is added to the storage coupling information B 8b of host b 2b (the state of reference number 160b). According to the present embodiment, only the CU is added and the configuration of the FC switch is not changed. Therefore, only the storage mapping information of reference number 1601a is added to the storage coupling information 160a and the storage mapping information of reference number 1601b is added to the storage coupling information 160b, but the FC path information is not changed.

As described, the host 2 side can constantly recognize the current adequate logical configuration of the one or more storage subsystems that it accesses without being conscious of the physical change of configuration of the storage subsystem 1. Therefore, the maintenance management of the whole storage system becomes efficient, and the number of steps of maintenance operations can be reduced. Further, since the storage coupling information 8 of the host 2 can be updated automatically, human errors can be reduced.

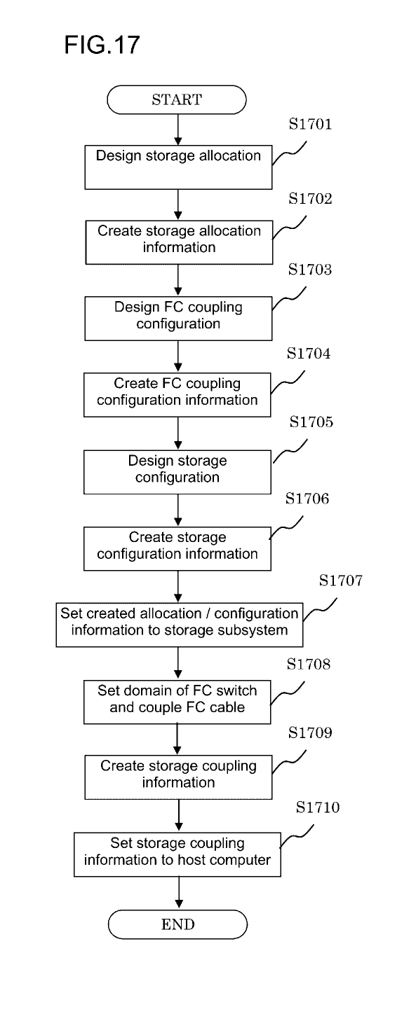

FIG. 17 is a flowchart showing the process for setting various configuration information of the storage system.

In S1701, the administrator of the storage system designs the allocation of the storage subsystem 1 to the host 2, and in S1702, creates a storage allocation information 6 based on the allocation of the designed storage subsystem 1.

Then, in S1703, the storage system administrator designs the coupling configuration of the FC switch, and in S1704, creates a FC coupling configuration information 9 based on the designed coupling configuration of the FC switch.

Thereafter, in S1705, the storage system administrator designs the storage configuration, and in S1706, creates a storage configuration information 7 based on the designed storage configuration. Then, the storage system administrator enters the created storage allocation information 6/storage configuration information 7 to the management device 5.

The entered storage allocation information/configuration information is transmitted by the management device 5 via the network 4 to the storage subsystem 1 and set as the device information of the storage subsystem 1 (S1707).

Next, in S1708, the storage system administrator designs the FC switch configuration, and sets the domain of the FC switch and couples FC cables between the FC switches.

In S1709, the storage system administrator creates a storage coupling information 8 based on the created storage allocation information 6 and the FC coupling configuration information 9. In S1710, the storage system administrator enters the created storage coupling information 8 to the management device 5.

The entered storage coupling information 8 is transmitted from the management device 5 via the network 4 to the host 2, and set as the coupling information to the storage subsystem 1.

Further, it is possible to have the storage allocation information 6 and the FC coupling configuration information 9 transmitted from the management device 5 to the respective storage subsystems where the information is set, have the storage configuration information 7 and the storage coupling information 8 created automatically and have the information set in each of the hosts 2 and the storage subsystems 1.

### Embodiment 2

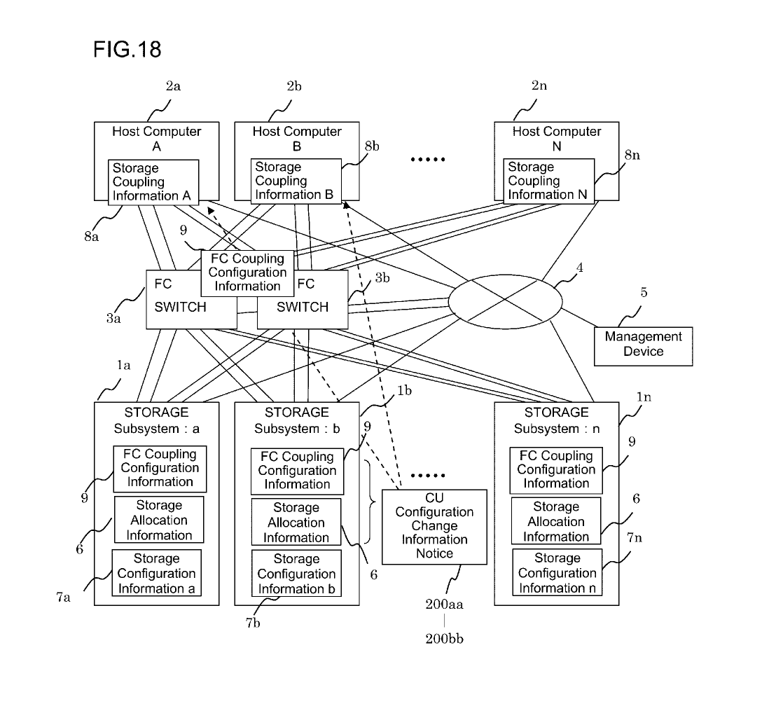

FIG. 18 is an explanatory view showing an overall configuration of the storage system according to embodiment 2.

According to the system configuration example illustrated in FIG. 1, the storage allocation information 6 is shared among the storage subsystems 1, and the change of CU configuration in any of the storage subsystems 1 can be recognized by the other storage subsystems 1, so that by changing the configuration of the storage subsystems 1 sequentially in order, the hosts 2 can recognize the correct CU information.

According to the overall configuration of the storage subsystem of embodiment 2 illustrated in FIG. 18, the FC coupling configuration information 9 is also taken into the storage subsystems 1 via the network 4, in addition to the storage allocation information 6. Then, similar to the storage allocation information 6, the FC coupling configuration information 9 is also shared among the storage subsystems 1, and the storage subsystem 1 having recognized that change in the FC coupling configuration information 9 updates the internally stored FC coupling configuration information 9, wherein either the storage subsystem 1 notifies the occurrence of change and the contents of change to the other storage subsystems 1 or the other storage subsystems 1 refer to the information automatically.

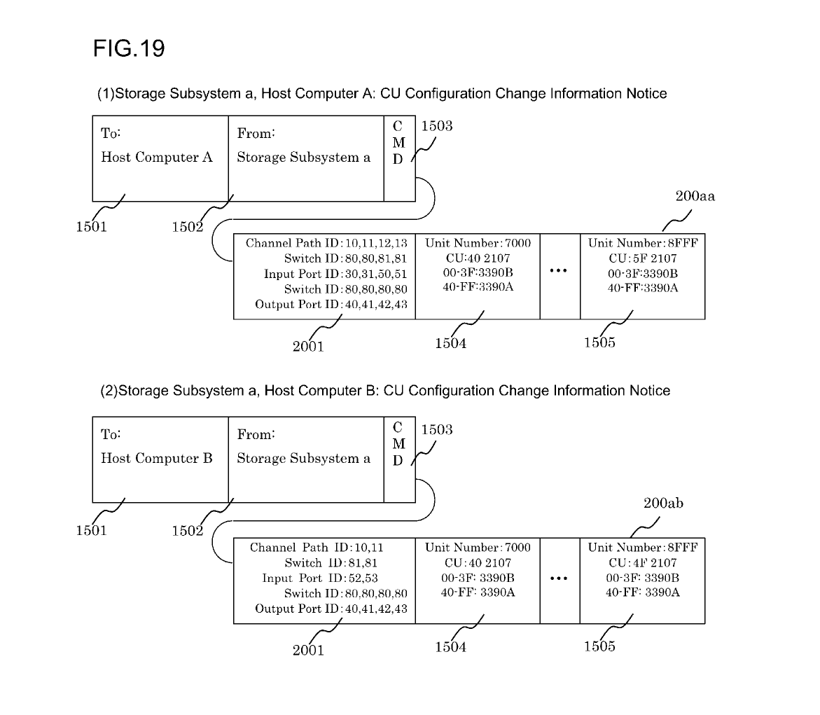

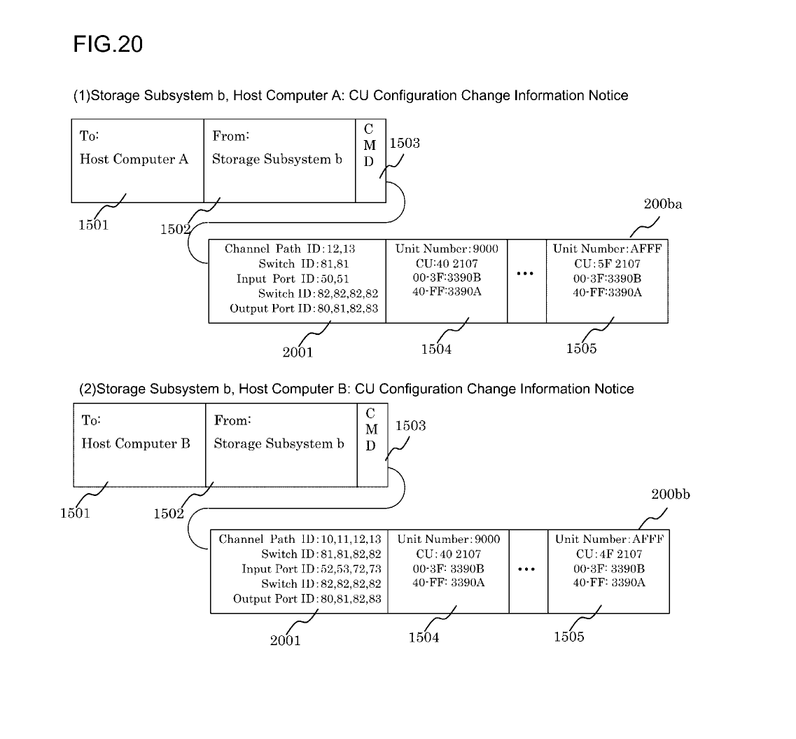

Thereby, for example, even if hosts or storage subsystems are newly added and the FC switch configuration has been changed, the CU configuration change information notice shown in FIGS. 19 and 20 can be created based on the storage allocation information 6 and the FC coupling configuration information 9 within the storage subsystem 1. Moreover, it is possible to have the created CU configuration change information notice transmitted from each of the storage subsystems 1 to the respective hosts 2, and to have the storage coupling information 8 created based on the CU configuration change information of the respective storage subsystems 1 received by the host 2.

FIG. 19 is an explanatory view showing the configuration of the CU configuration change information notice via the storage subsystem a according to embodiment 2. FIG. 20 is an explanatory view showing the configuration of the CU configuration change notice in storage subsystem b according to embodiment 2.

The difference between the configuration of CU configuration change information notice 200 illustrated in FIGS. 19 and 20 and the configuration of the CU configuration change information notice 150 illustrated in FIG. 15 is that a port coupling information 2001 (the FC path information of FIG. 6) has been added.

The port coupling information 2001 of CU configuration change information notice 200aa shown in FIG. 19 stores the coupling information between the storage subsystem a 1a and the host A 1a, that is, the port information of the storage subsystem a 1a, the port information of the host A 1a (Channel Path ID), and the port information of the FC switch 30 (SW ID: 80) and the FC switch 31 (SW ID: 81).

Similarly, the port coupling information 2001 of CU configuration change information notice 200ab stores the coupling information between the storage subsystem a 1a and the host B 1b.

Moreover, the port coupling information 2001 of CU configuration change information notice 200ba of FIG. 20 stores the coupling information between the storage subsystem b 1b and the host A 1a. Similarly, the port coupling information 2001 of CU configuration change information notice 200bb stores the coupling information between the storage subsystem b 1b and the host B 1b.

As described, according to a system in which the storage allocation information 6 and the FC coupling configuration information 9 are stored in the storage subsystem 1 side and the allocation information of the storage subsystem 1 is provided to the host 2 side, when an addition of a storage subsystem 1 is performed, the storage subsystem 1 side notifies that a storage subsystem has been added and the contents of the change of configuration to the host 2 side, where the update of the storage coupling information 8 is performed. Thereby, similar to embodiment 1, embodiment 2 enables the host to constantly recognize the current adequate configuration of the one or more storage subsystems 1 that the host accesses. Even if the storage subsystems 1 are allocated in a dispersed manner in physically distant locations, the update of storage coupling information 8 can be executed at the respective locations where the storage subsystems 1 are located.

Further, as described in embodiment 2, by simultaneously executing change of CU configuration in the storage subsystem a 1a and the storage subsystem b 1b and sending four CU configuration change information notices from the storage subsystem a 1a and the storage subsystem b 1b to the host A 1a and the host B 1b, it becomes possible to update all the respective storage coupling information in the host A 1a and host B 1b simultaneously. Thus, the maintenance performance of the whole storage system can be enhanced, such as the reduction of maintenance time.

The present invention is not restricted to the embodiments illustrated above, and can include various modifications. The embodiments are described in detail so as to facilitate understanding of the present invention, and it should be noted that not necessarily all the components illustrated in the embodiments are required for realizing the present invention. A portion of the configuration of an embodiment can be replaced with the configuration of another embodiment, or the configuration of a certain embodiment can be added to the configuration of another embodiment. Moreover, a portion of the configuration of each embodiment can be added to, deleted from or replaced with other configurations.

Furthermore, a portion or all of the above-illustrated configurations, functions, processing units, processing means and so on can be realized via a hardware configuration such as by designing an integrated circuit. Further, the configurations and functions illustrated above can be realized via software by the processor interpreting and executing programs realizing the respective functions.

The information such as the programs, tables and files for realizing the respective functions can be stored in a storage device such as a memory, a hard disk or a SSD (Solid State Drive), or in a memory media such as an IC card, an SD card or a DVD.

Only the control lines and information lines considered necessary for description are illustrated in the drawings, and not necessarily all the control lines and information lines required for production are illustrated. In actual application, almost all the configurations are mutually coupled.

### REFERENCE SIGNS LIST

1 Storage subsystem
2 Host computer
3 FC switch
4 Network
6 Storage allocation information
7 Storage configuration information
8 Storage coupling information
9 FC coupling configuration information
150, 200 CU configuration change information notice

1. A storage system having one or more storage subsystems coupled via a network with one or more host computers;
the storage subsystem comprising:
a storage device for storing data from the host computer; and
a control unit for controlling the storage device;
wherein the host computer has a storage coupling information for coupling to the storage subsystem;
the storage coupling information is composed of a coupling information of the host computer and the storage subsystem, and a configuration information of the storage device and the control unit;
the storage subsystem has a storage allocation information storing a configuration of the storage device and the control unit and an allocation position to the host computer; and
when the configuration of the storage subsystem is changed, the storage allocation information is updated, the configuration change information notice including the content of change of configuration is transmitted to the host computer, and the storage coupling information is updated based on the content of the configuration change information notice.

2. The storage system according to claim 1, wherein
the network stores a network coupling information indicating a coupling status of the host computer and the storage subsystem; and
the network coupling information is composed of a coupling port information of the host computer, a coupling port information of the storage subsystem, and a coupling information of the coupling ports.

3. The storage system according to claim 2, wherein
the storage allocation information includes a logical address information showing the allocation of the storage device in the host computer, an identification information and a type information of the control unit, and an identification information and a type information of the storage device; and
the storage coupling information is generated from the storage allocation information and the network information.

4. The storage system according to claim 3, wherein
the configuration change information notice further includes a request source information for identifying a storage subsystem requesting update of the storage coupling information, a request destination information for identifying a host computer of the request destination, and a configuration change type indicating the type of the change of configuration; and
the configuration change type is one or more of the following states: expansion, reduction, replacement or change of specification of the storage subsystem, the storage device or the control unit.

5. The storage system according to claim 4, wherein either the whole storage system or a management device managing the storage subsystem is coupled to the storage subsystem or the network.

6. The storage system according to claim 5, wherein
when the host computer cannot access the storage subsystem, if the cause of access incapability is a reduction of the storage subsystem, the storage device or the control unit,
a notice notifying that the cause of access incapability is the reduction of the storage subsystem is sent to the host computer or the management device.

7. The storage system according to claim 5, wherein
when the host computer cannot access the storage subsystem,
if the cause of access incapability is a failure instead of a reduction of the storage subsystem, the storage device or the control unit,
a notice notifying that the cause of access incapability is the failure of the storage subsystem is sent to the host computer or the management device.

8. The storage system according to claim 4, wherein
the configuration change information notice further includes a network coupling information.

9. The storage system according to claim 8, wherein
the configuration change information notice is transmitted from the storage subsystem to the host computer via a second network that differs from said network.

10. The storage system according to claim 9, wherein
a protocol of the network is a FC.

11. The storage system according to claim 9, wherein
a protocol of the second network is Ethernet.

12. A method for managing configuration information of a storage system, the information including
a storage allocation information for allocating a physical storage resource of a storage subsystem to a host computer; and
a storage coupling information which is a logical configuration information for the host computer to access the storage subsystem;
wherein the method updates the storage allocation information and the storage coupling information based on the content of change when a configuration of the physical storage resource of the storage subsystem is changed.
